(19) United States
(12) Patent Application Publication
(10) Pub. No.: US 2024/0288928 A1
(43) Pub. Date: Aug. 29, 2024

(54) METHODS AND APPARATUS TO IMPROVE SLEEP STATE DEMOTION WITH A HARDWARE POWER MONITOR

(71) Applicant: Intel Corporation, Santa Clara, CA (US)

(72) Inventors: Patrick Leung, Portland, OR (US); Jiancheng Tao, Shanghai (CN); Trevor Love, Wilsonville, OR (US); Jianfang Zhu, Portland, OR (US); Kristoffer Fleming, Chandler, AZ (US); Jun Liu, Shanghai (CN); Michael Mallen, Portland, OR (US); Duncan Glendinning, Chandler, AZ (US)

(21) Appl. No.: 18/572,672

(22) PCT Filed: Nov. 30, 2021
(86) PCT No.: PCT/CN2021/134291

§ 371 Date: Dec. 20, 2023

(51) Int. Cl. G06F 1/3296

(52) U.S. Cl. CPC G06F 1/3296

(57) ABSTRACT

Methods, apparatus, systems, and articles of manufacture are disclosed that improve sleep state demotion with a hardware power monitor. An example apparatus includes memory, and processor circuitry to perform at least one of the operations to instantiate: detector circuitry to detect power output data of the computing device via a hardware power monitor, power analyzer circuitry to determine the power output data for sleep states of the computing device based on multiple wake intervals, identifier circuitry to identify crossover thresholds at ones of the multiple wake intervals, and controller circuitry to limit the computing device to the crossover thresholds at ones of the multiple wake intervals.

### FIELD OF THE DISCLOSURE

This disclosure relates generally to computing devices and, more particularly, to methods and apparatus to improve sleep state demotion with a hardware power monitor.

### BACKGROUND

Computing devices, such and personal computers, laptops, mobile devices, etc., include many different components. One such component is a battery for supplying power to the device. Computing devices consume power from the battery during operation.

### BRIEF DESCRIPTION OF THE DRAWINGS

FIG. 1 is a block diagram of an example computing device.

FIG. 2 is a block diagram of further detail of example demotion circuitry of FIG. 1.

FIG. 3 is a graphical illustration showing power consumption as a function of wake time for multiple sleep states of a first computing device.

FIG. 4 is a graphical illustration showing power consumption as a function of wake time for multiple sleep states of a second computing device.

FIG. 5 is a graphical illustration showing power consumption as a function of wake time for multiple sleep states of a third computing device.

FIG. 6 is a graphical illustration of example power savings.

FIG. 7 is a flowchart representative of example machine readable instructions and/or example operations that may be executed by example processor circuitry to implement the example computing device of FIGS. 1 and 2.

FIG. 8 is a flowchart representative of example machine readable instructions and/or example operations that may be executed by example processor circuitry to implement the example computing device of FIGS. 1 and 2.

FIG. 9 is a flowchart representative of example machine readable instructions and/or example operations that may be executed by example processor circuitry to implement the example computing device of FIGS. 1 and 2.

FIG. 10 is a flowchart representative of example machine readable instructions and/or example operations that may be executed by example processor circuitry to implement the example computing device of FIGS. 1 and 2.

FIG. 11 is a block diagram of an example processing platform including processor circuitry structured to execute the example machine readable instructions and/or example operations of FIGS. 7-10 to implement the example computing device of FIGS. 1 and 2.

FIG. 12 is a block diagram of an example implementation of the processor circuitry of FIG. 11.

FIG. 13 is a block diagram of another example implementation of the processor circuitry of FIG. 11.

FIG. 14 is a block diagram of an example software distribution platform (e.g., one or more servers) to distribute software (e.g., software corresponding to the example machine readable instructions of FIGS. 7-10) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

### DETAILED DESCRIPTION

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

As used herein, “approximately” and “about” refer to dimensions that may not be exact due to manufacturing tolerances and/or other real world imperfections. As used herein “substantially real time” refers to occurrence in a near instantaneous manner recognizing there may be real world delays for computing time, transmission, etc. Thus, unless otherwise specified, “substantially real time” refers to real time+/−1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmed with instructions to perform specific operations and including one or more semiconductor-based logic devices (e.g., electrical hardware implemented by one or more transistors). Examples of processor circuitry include programmed microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of the processing circuitry is/are best suited to execute the computing task(s).

Computing systems, including personal computers and/or laptops, typically preserve power and manage performance when the system is in a sleep state (e.g., idle state, low power state, C state, etc.). As used herein, “sleep states” refer to the various power modes for computing devices wherein the device reduces the power consumed by unneeded and/or low priority subsystems. A computing device can have any number of sleep states and the power consumption can vary depending on the sleep state in which the device is operating and the device wake interval. As used herein, references to “wake interval” refer to a length of time a computing device has been in a sleep state (e.g., sleep mode, idle, etc.) before the device emerges from that sleep state. In other words, a wake interval (e.g., off duration) of 4 milliseconds (ms) indicates that the computing device was asleep (e.g., idle) for 4 ms and then awakened (e.g., activated by a user, activated by another computing device, etc.). Operating systems of computing devices can determine and control the sleep state the computing device enters. Also, operating systems can determine both the amount of power to supply to the computing devices when the devices are in a sleep state and the amount of power needed to wake the devices from that sleep state.

In order to wake a computing device from a sleep state, the operating system of the device wakes components of the device and, in turn, those components draw power from the battery to function. To wake the computing device from a deep (e.g., low power mode) sleep state will require more power from the battery compared to waking the device from a shallow (e.g., high power mode) sleep state. A computing device may attempt to conserve power by entering a deep sleep state, but the amount of power required to wake the device may inadvertently tax (e.g., drain, consume excessive power, etc.) the battery upon waking.

Examples disclosed herein improve and, in some cases, optimize the power consumption of a computing device. Examples disclosed herein identify the sleep state of a computing device that requires the lowest power consumption. Examples disclosed herein identify wake intervals corresponding to sleep states and crossover thresholds of the sleep states. Examples disclosed herein prolong battery life of the computing device by limiting (e.g., demoting) the device to the lowest power consumption sleep state.

Examples disclosed herein include a hardware power monitor to detect power output data of the computing device. The hardware power monitor can detect power output data at an input of a voltage regulator (VR). Examples disclosed herein include detector circuitry to detect the power output data via at least one of a platform power monitor of the computing device or a system on a chip (SoC) power monitor of the computing device. Examples disclosed herein include identifier circuitry to identify at least one of the crossover thresholds when first power output data of a first sleep state is equal to the power output data of a second sleep state, the first sleep state different from the second sleep state. Examples disclosed herein include controller circuitry to limit the computing device to a lower sleep state based on at least one of the crossover thresholds.

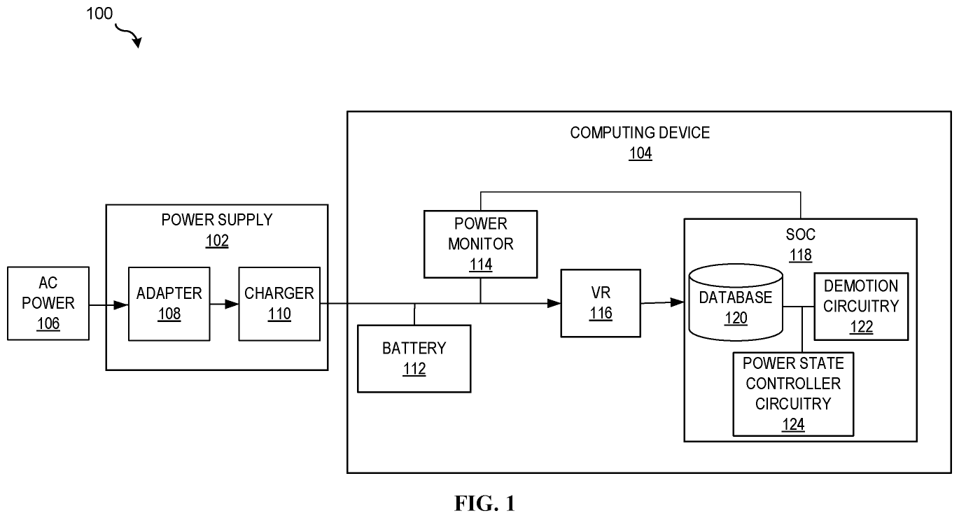

FIG. 1 is a block diagram of an example computing environment 100 that includes a power supply 102, a computing device 104, and AC power 106. The power supply 102 includes an adapter 108 and a charger 110. The power supply 102 supplies power to the computing device 104. The adapter 108 adapts (e.g., changes, converts, etc.) the voltage from the AC power 106 to ensure the device 104 receives sufficient power.

The charger 110 receives electrical current from the adapter 108 to charge the computing device 104. In some examples, the charger 110 converts adapter 108 voltage to system voltage. In some examples, the charger 110 charges a battery of the computing device 104. In some examples, the example power supply 102 and AC power 106 supply power to the computing device 104. However, the battery 112 can supply power to the computing device 104.

The example computing environment 100 of FIG. 1 includes the computing device 104. The computing device 104 of FIG. 1 may be instantiated (e.g., creating an instance of, bring into being for any length of time, materialize, implement, etc.) by processor circuitry such as a central processing unit executing instructions. Additionally or alternatively, the computing device 104 of FIG. 1 may be instantiated (e.g., creating an instance of, bring into being for any length of time, materialize, implement, etc.) by an ASIC or an FPGA structured to perform operations corresponding to the instructions. It should be understood that some or all of the circuitry of FIG. 1 may, thus, be instantiated at the same or different times. Some or all of the circuitry may be instantiated, for example, in one or more threads executing concurrently on hardware and/or in series on hardware. Moreover, in some examples, some or all of the circuitry of FIG. 1 may be implemented by one or more virtual machines and/or containers executing on the microprocessor.

The computing device 104 of the example of FIG. 1 includes, among other components, a battery 112, a power monitor 114, a voltage regulator (VR) 116, and a System on a Chip (SoC) 118. The computing device 104 receives power from the power supply 102.

The example battery 112 is charged by the power supply 102 and supplies power (e.g., DC power) to the computing device 104. In some examples, the battery 112 is a hardware component of a computing device 104.

The example power monitor 114 monitors the power consumed by the device 104. In some examples, the power monitor is a hardware component of the computing device 104. However, the power monitor 114 can be software.

The example VR 116 regulates the voltage supplied to the device 104. In some examples, the VR 116 is a hardware component (e.g., a device, a circuit, etc.). In some examples, the VR 116 maintains a constant voltage supply to the device 104.

The example SoC 118 is an integrated circuit of a computing platform. In some examples, the SoC 118 can include a central processing unit (CPU), input and output ports, memory, etc. to perform signal processing and/or wireless communication between components of a device (e.g., the device 104). The SoC 118 includes a database 120, demotion circuitry 122, and power state controller circuitry 124.

The example database 120 stores the power data, calculations (e.g., analysis, crossover thresholds, etc.) from the demotion circuitry 122, and device 104 information (e.g., SoC 118 settings, Original Equipment Manufacturer (OEM) data, settings of the battery 112, etc.).

The example demotion circuitry 122 determines sleep states of the device 104 based on wake intervals and power output data. In some examples, the demotion circuitry 122 is added to the software and/or firmware components of the computing device 104.

The example power state controller circuitry 124 sets (e.g., limits, controls, etc.) the sleep state of the computing device 104. In some examples, the power state controller circuitry 124 can set the device 104 to the deepest sleep state when the device 104 is idle, resulting in higher power consumption (e.g., drain of the battery 112).

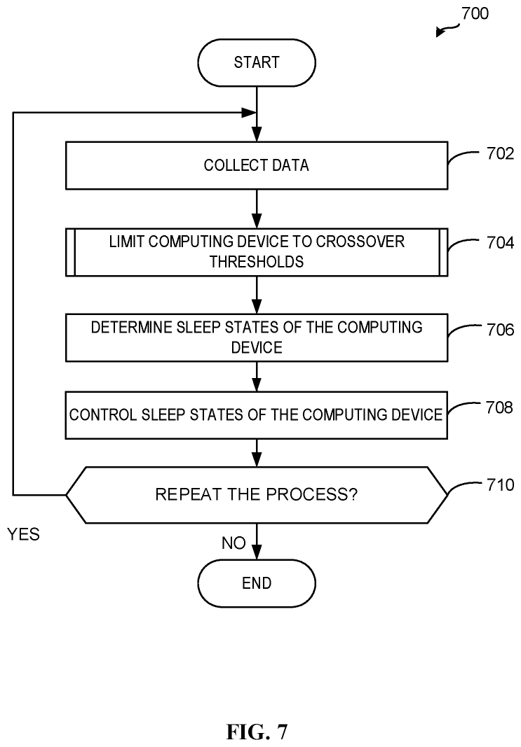

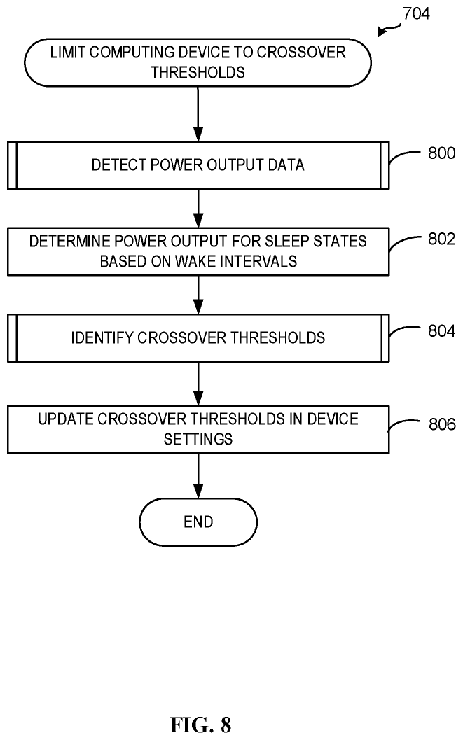

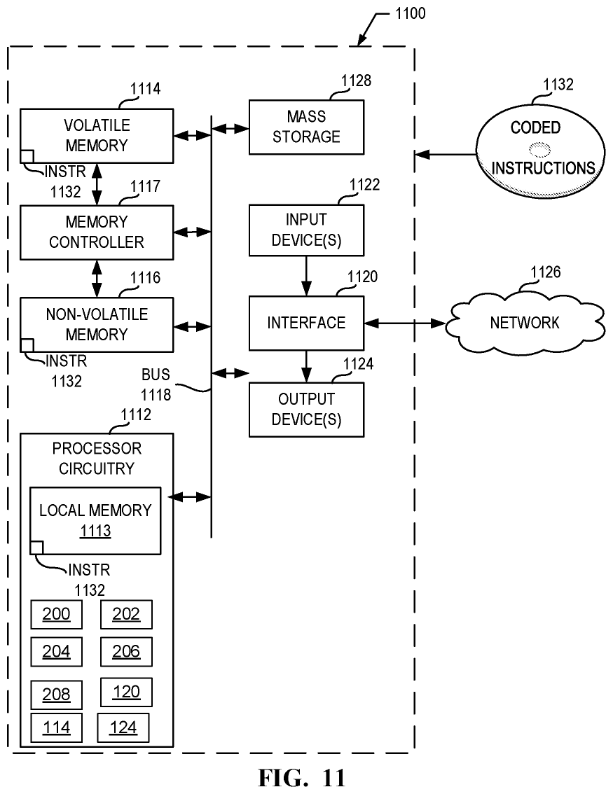

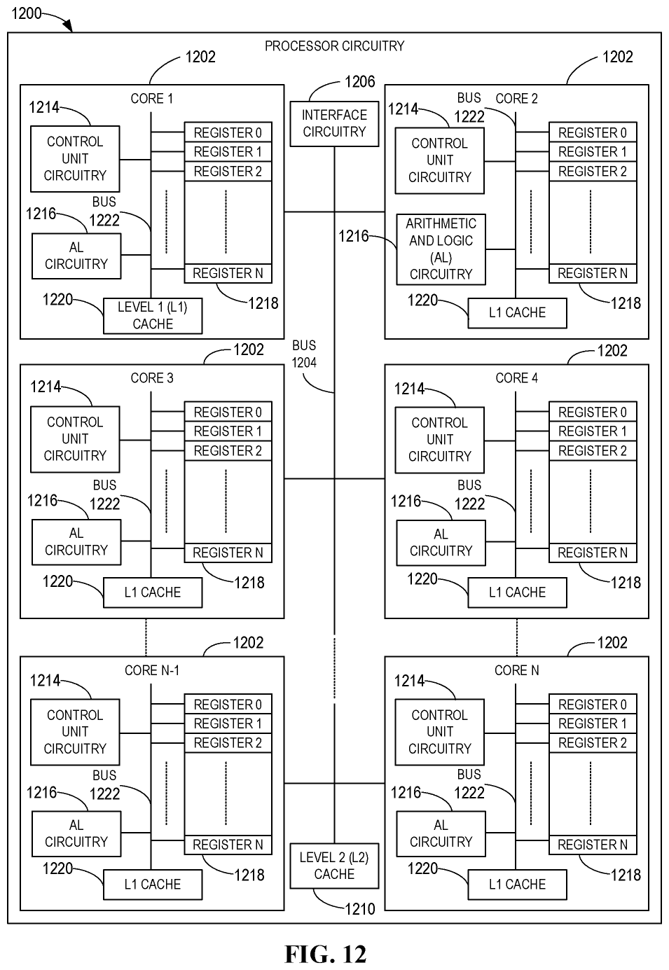

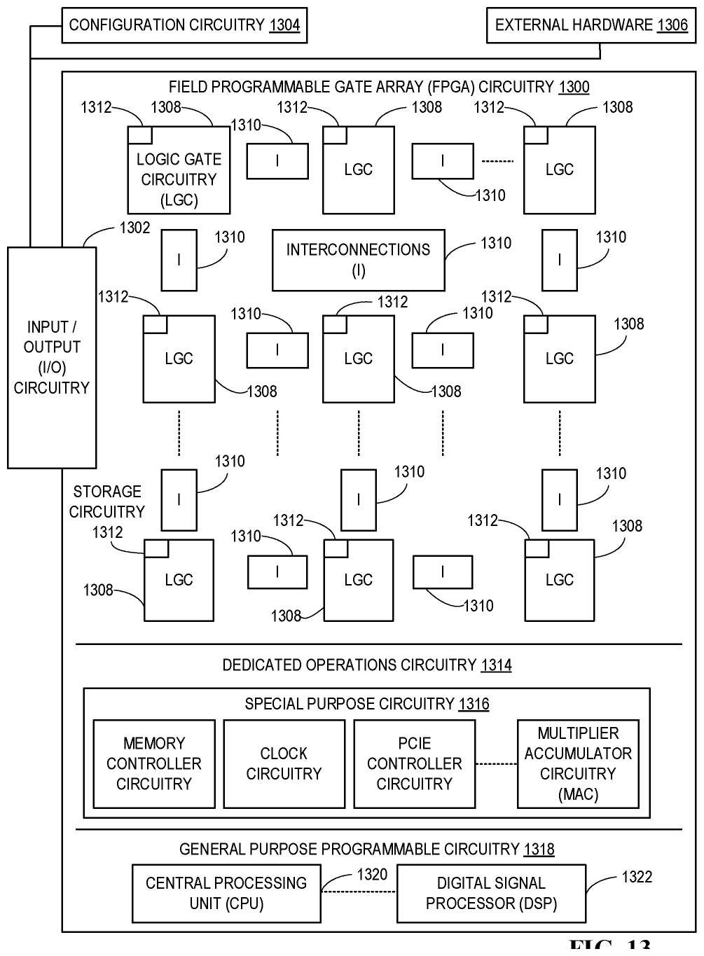

In some examples, the computing device 104 includes means for controlling the sleep states of the device 104. For example, the means for controlling may be implemented by power state controller circuitry 124. In some examples, the power state controller circuitry 124 may be instantiated by processor circuitry such as the example processor circuitry 1112 of FIG. 11. For instance, the power state controller circuitry 124 may be instantiated by the example general purpose processor circuitry 1200 of FIG. 12 executing machine executable instructions such as that implemented by at least block 708 of FIG. 7 and block 806 of FIG. 8. In some examples, the power state controller circuitry 124 may be instantiated by hardware logic circuitry, which may be implemented by an ASIC or the FPGA circuitry 1300 of FIG. 13 structured to perform operations corresponding to the machine readable instructions. Additionally or alternatively, the power state controller circuitry 124 may be instantiated by any other combination of hardware, software, and/or firmware. For example, the power state controller circuitry 124 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The example computing device 104 utilizes the power monitor 114 to collect power data (e.g., power output data) from the battery 112. In FIG. 1, the power monitor 114 is added to an input of the VR 116. Thus, the power data can include SoC 118 and VR 116 loss as power is supplied to the computing device 104. In some examples, the SoC 118 can collect power data from the battery 112. However, the SoC 118 can collect power data from the VR 116. Depending on the sleep state of the computing device 104, the power data from the battery 112 will vary. For example, a shallow sleep state (e.g., C4, C6, etc.) of the device 104 can result in a high power output of the battery 112. In some examples, a deep sleep state (e.g., C8, C10, etc.) can result in a low power output of the battery 112.

In the example of FIG. 1, the SoC 118 utilizes the power state controller circuitry 124 to set (e.g., limit, control, etc.) the sleep state of the computing device 104. The power state controller circuitry 124 can receive data from the demotion circuitry 122 and the database 120. The demotion circuitry 122 receives the power data (e.g., power output data) from at least one of the power monitor 114 or software in the SoC 118. The collected power data is analyzed by the demotion circuitry 122 to determine optimal sleep states of the computing device 104.

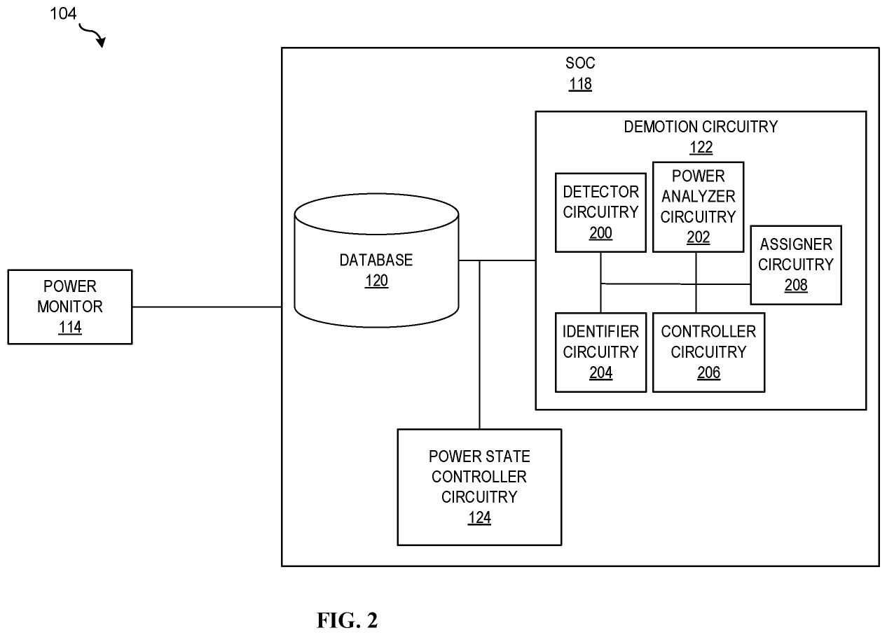

FIG. 2 is a block diagram showing further detail of one example of the SoC 118 to improve, and in some cases, optimize, the power consumption of the computing device 104. The example computing device 104 includes the power monitor 114 and the System on a Chip (SoC) 118. The SoC 118 includes the database 120, the demotion circuitry 122, and the power state controller circuitry 124. The example demotion circuitry 122 includes detector circuitry 200, power analyzer circuitry 202, identifier circuitry 204, controller circuitry 206, and assigner circuitry 208.

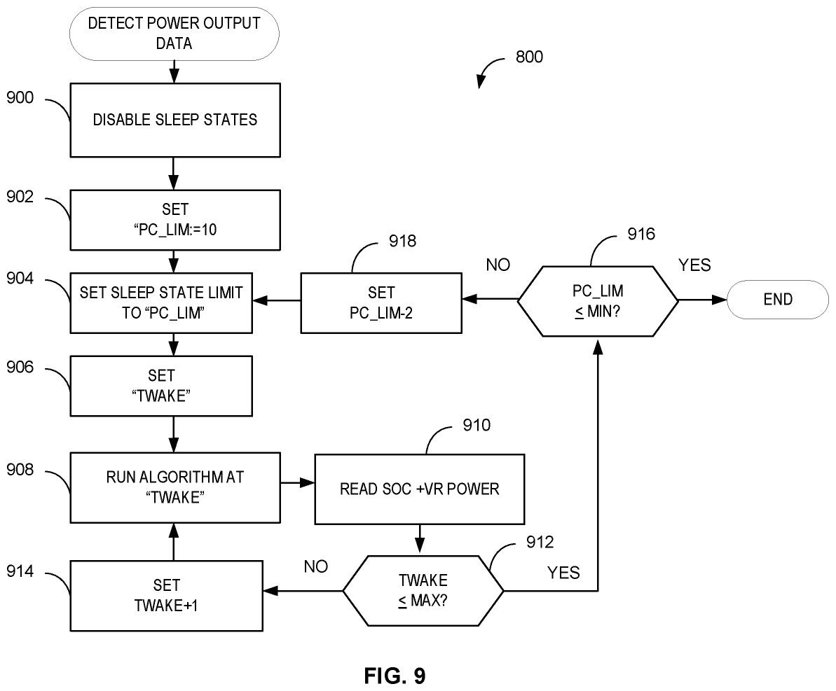

The example detector circuitry 200 collects (e.g., detects) the power output data of the computing device 104. In some examples, the detector circuitry 200 collects data pertaining to a sleep state of the device 104. For example, the detector circuitry 200 detects a length of time the device 104 has been idle (e.g., idle duration, off duration, sleep mode). In some examples, the computing device 104 includes means for detecting power output data of the computing device 104. For example, the means for detecting may be implemented by the detector circuitry 200. In some examples, the detector circuitry 200 may be instantiated by processor circuitry such as the example processor circuitry 1112 of FIG. 11. For instance, the detector circuitry 200 may be instantiated by the example general purpose processor circuitry 1200 of FIG. 12 executing machine executable instructions such as that implemented by at least blocks 702 of FIG. 7, block 802 of FIG. 8, and blocks 900-916 of FIG. 9. In some examples, the detector circuitry 200 may be instantiated by hardware logic circuitry, which may be implemented by an ASIC or the FPGA circuitry 1300 of FIG. 13 structured to perform operations corresponding to the machine readable instructions. Additionally or alternatively, the detector circuitry 200 may be instantiated by any other combination of hardware, software, and/or firmware. For example, the detector circuitry 200 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The example power analyzer circuitry 202 can determine the power output data for multiple sleep states (e.g., C states, power states, sleep modes) of the computing device 104. Additionally or alternatively, the example power analyzer circuitry 202 can determine the power output data for multiple sleep states based on multiple wake intervals. For example, the power analyzer circuitry 202 can collect the power output data for a wake interval of 4.5 ms. However, the example power analyzer circuitry 202 can collect the power output data over a range of wake intervals (e.g., from 2 ms to 16 ms).

In some examples, the computing device 104 includes means for determining the power output data for sleep states of the computing device 104 based on multiple wake intervals. For example, the means for determining may be implemented by the power analyzer circuitry 202. In some examples, the power analyzer circuitry 202 may be instantiated by processor circuitry such as the example processor circuitry 1112 of FIG. 11. For instance, the power analyzer circuitry 202 may be instantiated by the example general purpose processor circuitry 1200 of FIG. 12 executing machine executable instructions such as that implemented by at least block 802 of FIG. 8. In some examples, power analyzer circuitry 202 may be instantiated by hardware logic circuitry, which may be implemented by an ASIC or the FPGA circuitry 1300 of FIG. 13 structured to perform operations corresponding to the machine readable instructions. Additionally or alternatively, the power analyzer circuitry 202 may be instantiated by any other combination of hardware, software, and/or firmware. For example, the power analyzer circuitry 202 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The example identifier circuitry 204 identifies crossover thresholds at ones of the multiple wake intervals. For example, a crossover threshold can define a wake interval at which at least two sleep states have equal power output values. In some examples, multiple crossover thresholds can be defined as multiple sleep states of the device 104 are analyzed. The example identifier circuitry 204 can identify crossover thresholds for devices (e.g., the computing device 104 that includes varying device settings, varying OEMs, varying battery settings, etc.

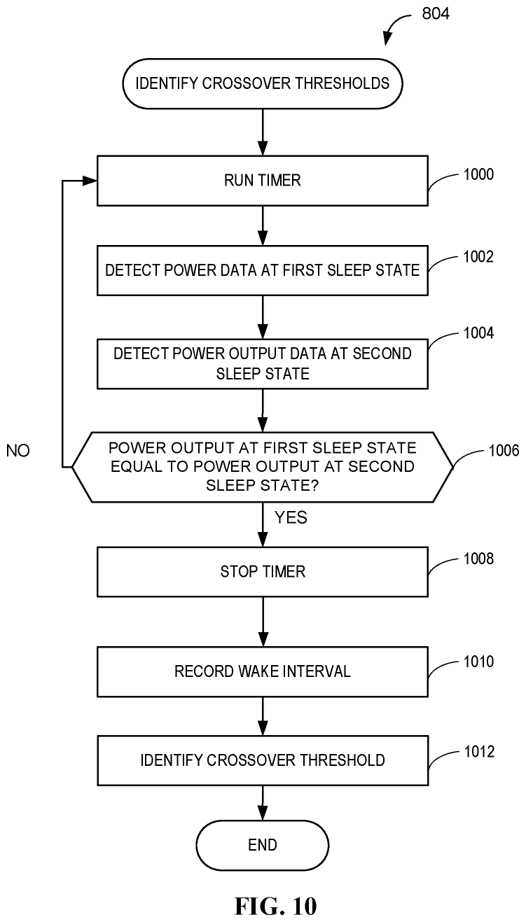

In some examples, the computing device 104 includes means for identifying crossover thresholds at ones of the multiple wake intervals. For example, the means for identifying may be implemented by the identifier circuitry 204. In some examples, the identifier circuitry 204 may be instantiated by processor circuitry such as the example processor circuitry 1112 of FIG. 11. For instance, the identifier circuitry 204 may be instantiated by the example general purpose processor circuitry 1200 of FIG. 12 executing machine executable instructions such as that implemented by at least block 804 of FIG. 8 and blocks 1000-1012 of FIG. 10. In some examples, the identifier circuitry 204 may be instantiated by hardware logic circuitry, which may be implemented by an ASIC or the FPGA circuitry 1300 of FIG. 13 structured to perform operations corresponding to the machine readable instructions. Additionally or alternatively, the identifier circuitry 204 may be instantiated by any other combination of hardware, software, and/or firmware. For example, the identifier circuitry 204 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The example controller circuitry 206 limits the computing device 104 to the crossover thresholds at ones of the multiple wake intervals. In some examples, the controller circuitry 206 limits the computing device to a higher sleep state based on at least one of the crossover thresholds.

In some examples, the computing device 104 includes means for limiting the computing device 104 to the crossover thresholds at ones of the multiple wake intervals. For example, the means for limiting may be implemented by controller circuitry 206. In some examples, the controller circuitry 206 may be instantiated by processor circuitry such as the example processor circuitry 1112 of FIG. 11. For instance, the controller circuitry 206 may be instantiated by the example general purpose processor circuitry 1200 of FIG. 12 executing machine executable instructions such as that implemented by at least block 708 of FIG. 7. In some examples, the controller circuitry 206 may be instantiated by hardware logic circuitry, which may be implemented by an ASIC or the FPGA circuitry 1300 of FIG. 13 structured to perform operations corresponding to the machine readable instructions. Additionally or alternatively, the controller circuitry 206 may be instantiated by any other combination of hardware, software, and/or firmware. For example, the controller circuitry 206 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The example assigner circuitry 208 determines a sleep state of the computing device 104 based on at least one of the crossover thresholds. For example, the assigner circuitry 208 can change (e.g., instruct) the sleep state of the device 104 from a high power consumption sleep state to a lower power consumption sleep state depending on the crossover thresholds of the device 104 and/or the length of the wake interval (e.g., off duration, idle duration, etc.).

In some examples, the computing device 104 includes means for assigning to determine a sleep state of the computing device 104 based on at least one of the crossover thresholds. For example, the means for assigning may be implemented by assigner circuitry 208. In some examples, the assigner circuitry 208 may be instantiated by processor circuitry such as the example processor circuitry 1112 of FIG. 11. For instance, the assigner circuitry 208 may be instantiated by the example general purpose processor circuitry 1200 of FIG. 12 executing machine executable instructions such as that implemented by at least block 706 of FIG. 7. In some examples, the assigner circuitry 208 may be instantiated by hardware logic circuitry, which may be implemented by an ASIC or the FPGA circuitry 1300 of FIG. 13 structured to perform operations corresponding to the machine readable instructions. Additionally or alternatively, the assigner circuitry 208 may be instantiated by any other combination of hardware, software, and/or firmware. For example, the assigner circuitry 208 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The detector circuitry 200 detects power output data from the SoC 118. In some examples, the SoC 118 receives the power output data from the power monitor 114. In some examples, the power monitor 114 is at least one of hardware or software of the computing device 104. For example, the detector circuitry 200 can detect the power output data at the input of the VR 116.

The example detector circuitry 200 sends the power output data to the example power analyzer circuitry 202 such that the power analyzer circuitry 202 can determine the power output data for multiple sleep states based on multiple wake intervals. Based on the power output data analyzed by the power analyzer circuitry 202, the identifier circuitry 204 can identify multiple crossover thresholds. The example controller circuitry 206 limits the device 104 to the thresholds identified by the identifier circuitry 204. In some examples, the controller circuitry 206 sends data pertaining to sleep state limits and/or the crossover thresholds to the power state controller circuitry 124 to update the settings of the SoC 118.

The example power state controller circuitry 124 sets (e.g., limits, controls, etc.) the sleep state of the computing device 104. The power state controller circuitry 124 can receive data from the demotion circuitry 122 and the database 120. In some examples, the power state controller circuitry 124 can set the device 104 to the deepest sleep state when the device 104 is idle, resulting in a nonoptimal power consumption (e.g., drain of the battery 112). In particular, excessive power can be consumed by the battery 112 when the device 104 is woken back up from a deep sleep state. In some examples, the power state controller circuitry 124 can receive data and/or instruction from the demotion circuitry 122 and the database 120 to improve usage of the battery 112 (e.g., power consumption of the device 104 and/or the computing environment 100). Additionally or alternatively, the power state controller circuitry 124 receives data (e.g., power output data, sleep states, sleep state instructions) from the assigner circuitry 208 to control the sleep states of the device 104.

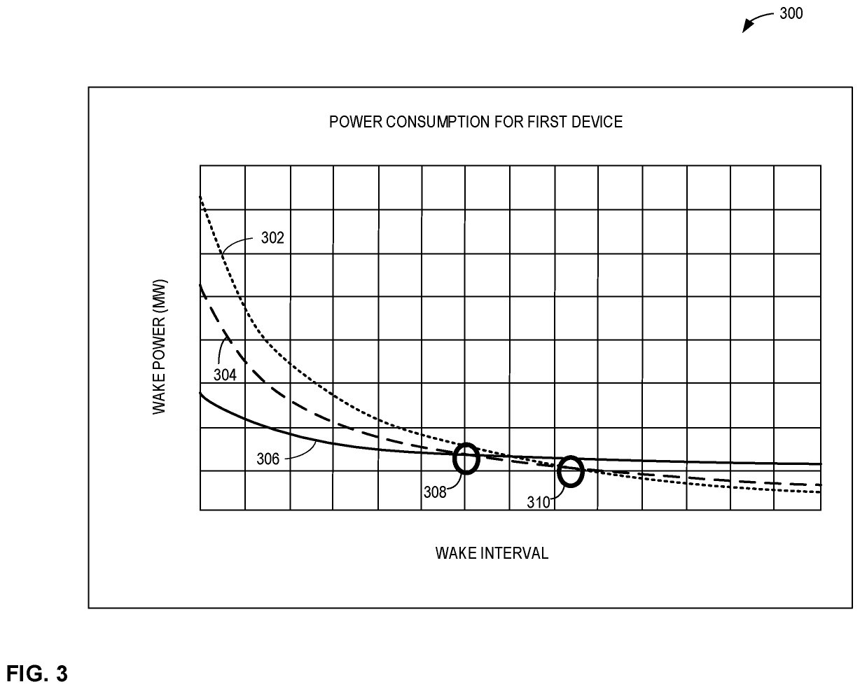

In the illustrated example of FIG. 3, a graphical illustration 300 includes an example first plot 302, an example second plot 304, and an example third plot 306. In the example of FIG. 3, the first plot 302 represents the power output data (e.g., wake power in milliWatts (mW)) of the battery 112 of a first device (e.g., the device 104) in a first sleep state as the wake interval increases. In the example of FIG. 3, the second plot 304 represents the power output data of the battery 112 of the first device in a second sleep state as the wake interval increases. In the example of FIG. 1, the third plot 306 represents the power output data of the battery 112 of the first device in a third sleep state as the wake interval increases. In the example graphical illustration 300 of FIG. 3, the power output data (e.g., the wake power) can be defined as the amount of power required to wake the first device (e.g., the device 104).

The example graphical illustration 300 includes crossover thresholds 308 and 310. The example crossover threshold 308 is defined when the power output data from the third plot 306 is equal to the power output data from the second plot 304. The example crossover threshold 308 is defined at a first wake interval (e.g., 8 ms). The example crossover threshold 310 is defined when the power output data from the second plot 304 is equal to the first plot 302. The example crossover threshold 310 is defined at a second wake interval (e.g., 11 ms).

In some examples, the data from the graphical illustration 300 is collected by the example demotion circuitry 122 to improve the life (e.g., consumption, available energy, etc.) of the battery 112. The example graphical illustration 300 describes the power output data for the first device (e.g., a known device, the computing device 104, etc.)

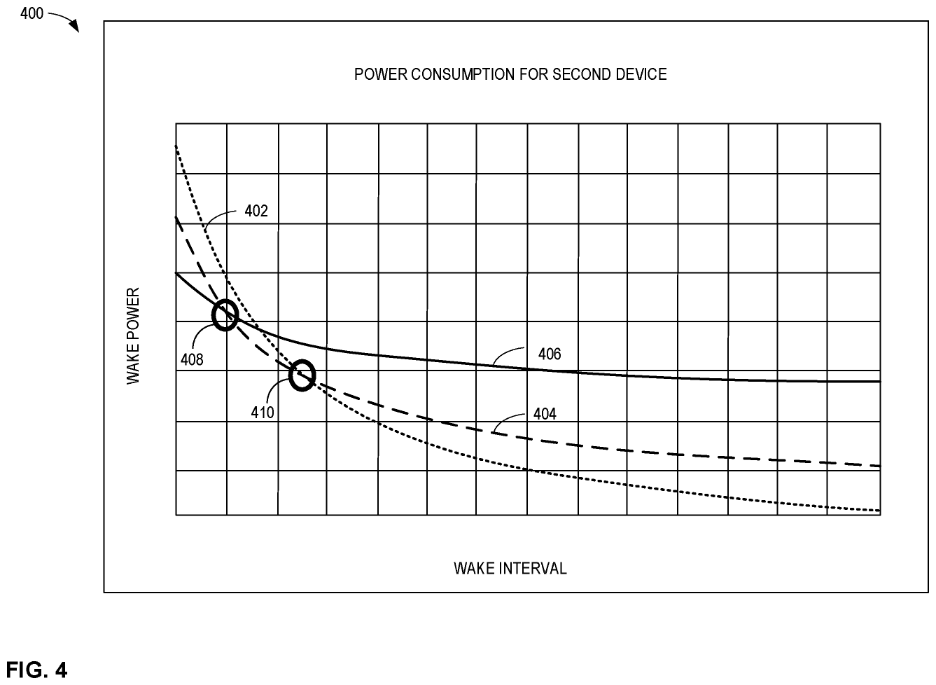

In the illustrated example of FIG. 4, a graphical illustration 400 includes an example plots 402, 404, and 406. The example graphical illustration 400 of FIG. 4 is similar to the graphical illustration 300 of FIG. 3, but, instead, a second device is analyzed for power output data. For example, the second device can differ from the first device based on platform VR design, OEM design, SoC settings, etc. In FIG. 4, crossover thresholds 408 and 410 occur at wake intervals different from (e.g., earlier than, later than, etc.) the wake intervals corresponding to the crossover thresholds 308 and 310 of FIG. 3. For example, crossover threshold 408 can be defined at a 3 ms wake interval and crossover threshold 410 can be defined at a 4.5 ms wake interval.

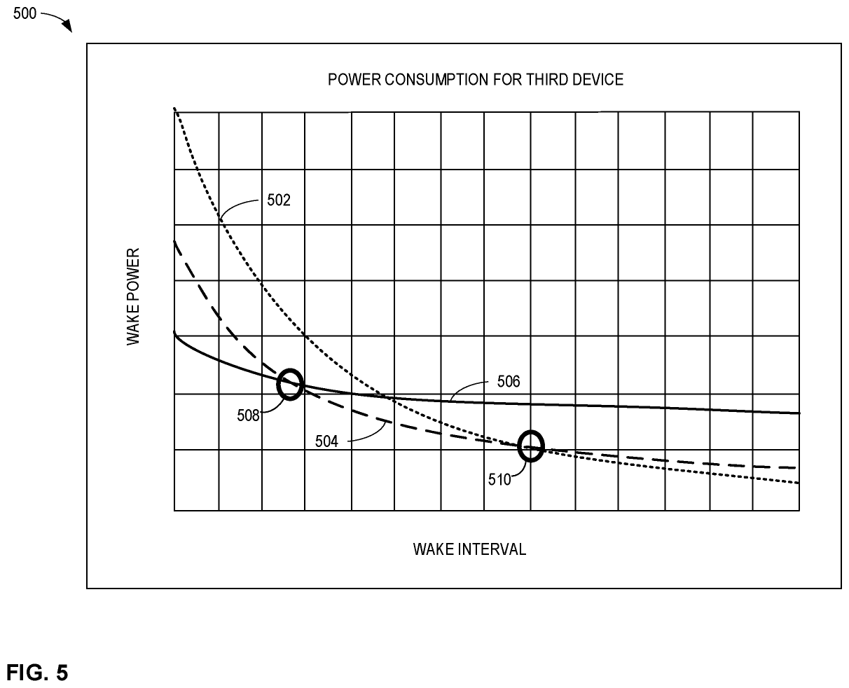

In the illustrated example of FIG. 5, a graphical illustration 500 includes an example plots 502, 504, and 506. The example graphical illustration 500 of FIG. 5 is similar to the graphical illustration 300 of FIG. 3 and the graphical illustration 400 of FIG. 4, but, instead, a third device is analyzed for power output data. For example, the third device can differ from the second device and the first device based on platform VR design, OEM design, SoC settings, etc. In FIG. 4, crossover thresholds 508 and 510 occur at wake intervals different from (e.g., earlier than, later than, etc.) the wake intervals corresponding to the crossover thresholds 308 and 310 of FIG. 3 and/or the wake intervals corresponding to the crossover threshold 408 and 410. For example, crossover threshold 508 can be defined at a 4.5 ms wake interval and crossover threshold 510 can be defined at a 10 ms wake interval.

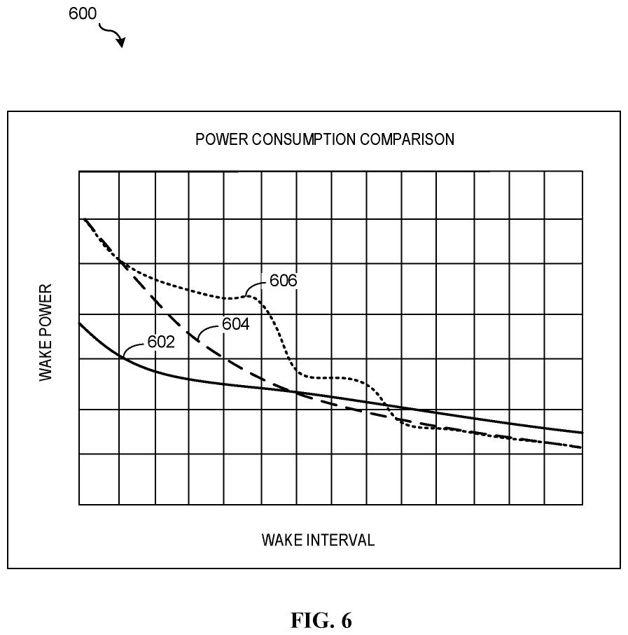

In the illustrated example of FIG. 6, a graphical illustration 600 includes example plots 602, 604, and 606. In the example of FIG. 6, the plot 602 represents the power output data of the battery 112 of the first device limited to the crossover thresholds 308, 310. In the example of FIG. 6, the plot 406 represents the power output data of the battery 112 of the second device limited to the crossover thresholds 408, 410. In the example of FIG. 6, the plot 602 represents the power output data of the battery 112 of the second device without being limited to the crossover thresholds 408, 410. Thus, the example graphical illustration 600 represents to the potential power savings of the implementation of the demotion circuitry 122 and crossover thresholds (e.g., crossover thresholds 308, 310, 408, 410). For example, plot 604 consumes less power over time compared to plot 606. Thus, plot 604 is more efficient (e.g., improved, optimized, etc.) than plot 606.

While an example manner of implementing the computing device 104 of FIG. 1 is illustrated in FIGS. 1 and 2, one or more of the elements, processes, and/or devices illustrated in FIGS. 1 and 2 may be combined, divided, re-arranged, omitted, eliminated, and/or implemented in any other way. Further, the example detector circuitry 200, the example power analyzer circuitry 202, the example identifier circuitry 204, the example controller circuitry 206, the example assigner circuitry 208, the example power state controller circuitry 124, the example power monitor 114 and/or, more generally, the example computing device 104 of FIG. 1, may be implemented by hardware alone or by hardware in combination with software and/or firmware. Thus, for example, any of the example detector circuitry 200, the example power analyzer circuitry 202, the example identifier circuitry 204, the example controller circuitry 206, the example assigner circuitry 208, the example power state controller circuitry 124, the example power monitor 114 and/or, more generally, the example computing device 104, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example computing device 104 of FIG. 1 may include one or more elements, processes, and/or devices in addition to, or instead of, those illustrated in FIGS. 1 and 2, and/or may include more than one of any or all of the illustrated elements, processes, and devices.

Flowcharts representative of example hardware logic circuitry, machine readable instructions, hardware implemented state machines, and/or any combination thereof for implementing the example computing device 104 of FIGS. 1 and 2 is shown in FIG. 11. The machine readable instructions may be one or more executable programs or portion(s) of an executable program for execution by processor circuitry, such as the processor circuitry 1112 shown in the example processor platform 1100 discussed below in connection with FIG. 11 and/or the example processor circuitry discussed below in connection with FIGS. 12 and/or 13. The program may be embodied in software stored on one or more non-transitory computer readable storage media such as a compact disk (CD), a floppy disk, a hard disk drive (HDD), a solid-state drive (SSD), a digital versatile disk (DVD), a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program is described with reference to the flowchart illustrated in FIG. 11, many other methods of implementing the example computing device 104 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU), etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 7-10 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium and non-transitory computer readable storage medium are expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 7 is a flowchart representative of example machine readable instructions and/or example operations 700 that may be executed and/or instantiated by processor circuitry to implement the computing device 104. The machine readable instructions and/or operations 700 of FIG. 7 begin at block 702, at which the example detector circuitry 200 collects data pertaining to a sleep state of the device 104. For example, the detector circuitry 200 detects a length of time the device 104 has been idle (e.g., idle duration, off duration, sleep mode).

At block 704, the example controller circuitry 206 limits the computing device 104 to the crossover thresholds (e.g., the crossover thresholds 308, 310, 408, 410, 508, 510) further described in conjunction with FIG. 8. In some examples, the controller circuitry 206 limits the computing device 104 to the crossover thresholds at ones of the multiple wake intervals. In some examples, the controller circuitry 206 sends data to the power state controller circuitry 124 to update the settings of the SoC 118. In some examples, the controller circuitry 206 limits the computing device to a lower sleep state based on at least one of the crossover thresholds.

At block 706, the example assigner circuitry 208 determines sleep states (e.g., the sleep state, the sleep state limit, etc.) of the computing device 104. In some examples, the assigner circuitry 208 can change the sleep state of the device 104 from a high power consumption sleep state to a lower power consumption sleep state depending on the crossover thresholds of the device 104 and/or the length of the wake interval. For example, in FIG. 4, the assigner circuitry 208 can change the sleep state of the device 104 from the higher power consumption sleep state of plot 406 to the lower power consumption sleep state of plot 404 based on the crossover threshold 408. At block 708, the power state controller circuitry 124 controls the sleep states of the computing device 104. In some examples, the power state controller circuitry 124 receives data (e.g., power output data, sleep states, sleep state instructions) from the assigner circuitry 208 to control the sleep states of the device 104.

At block 708, the power state controller circuitry 124 controls the sleep states of the computing device 104.

At block 710, is it determined whether to repeat the process. If the process is to be repeated (block 710), control of the process returns to block 702. Otherwise, the process ends.

FIG. 8 is a flowchart representative of example machine readable instructions and/or example operations 700 that may be executed and/or instantiated by processor circuitry to implement the computing device 104, as described above in conjunction with block 704 of FIG. 7. The machine readable instructions and/or operations of FIG. 8 begin at block 800, at which the example detector circuitry 200 collects data pertaining to a sleep state of the device 104, further described in conjunction with FIG. 9. In some examples, the detector circuitry 200 can detect the power output data at an input of the VR 116. In some examples, the detector circuitry 200 can collect (e.g., detect) power output data from the power monitor 114, wherein the power monitor 114 can be hardware and/or software of the computing device 104.

At block 802, the example power analyzer circuitry 202 determines the power output data for sleep states of the computing device 104 based on multiple wake intervals. In some examples, the power analyzer circuitry 202 can collect the power output data over a range of wake intervals (e.g., from 2 ms to 16 ms).

At block 804, the example identifier circuitry 204 identifies crossover thresholds, further described in conjunction with FIG. 10. In some examples, the identifier circuitry 204 identifies crossover thresholds (e.g., crossover thresholds 308, 310, 408, 410, 508, 510) at ones of the multiple wake intervals. However, the identifier circuitry 204 can identify at least one crossover threshold (e.g., crossover threshold 308) based on the data collected by the detector circuitry 200 and/or the power analyzer circuitry 202. In some examples, multiple crossover thresholds can be defined as multiple sleep states of the device 104 are analyzed.

At block 806, the example power state controller circuitry 124 updates (e.g., changes, modifies, etc.) the crossover thresholds (e.g., the crossover thresholds 308, 310, 408, 410, 508, 510) in the device 104 settings (e.g., the SoC 118). Then, the process ends.

FIG. 9 is a flowchart representative of example machine readable instructions and/or example operations that may be executed and/or instantiated by processor circuitry to implement the computing device 104, as described above in conjunction with block 800 of FIG. 8. The machine readable instructions and/or operations of FIG. 9 begin at block 900, at which the example detector circuitry 200 disables the current sleep state settings (e.g., current demotion circuitry) of the SoC 118 of the computing device 104. In some examples, the detector circuitry 200 disables the current sleep states so that the detector circuitry 200 can update the sleep states.

At block 902, the detector circuitry 200 sets the limit of the sleep states to 10 (e.g., C10, power state 10, sleep state 10). In some examples, the sleep state limit represents the deepest sleep state of the computing device. In some examples, the sleep state limit can be illustrated as plot 302, plot 402, and/or plot 502.

At block 904, the detector circuitry 200 collects data for the sleep state limit (e.g., 10, C10, power state 10, sleep state 10).

At block 906, the detector circuitry 200 determines a wake interval at which to collect the power data. In some examples, the wake interval is 2 ms.

At block 908, the detector circuitry 200 runs an algorithm (e.g., wake micro app). In some examples, the algorithm exercises the SoC 118 in the sleep state limit at multiples of the set wake interval (e.g., 2 ms).

At block 910, the detector circuitry 200 collects the power data from the power monitor 114. In some examples, the detector circuitry 200 collects the power data from the SoC 118 and/or the VR 116.

At block 912, the detector circuitry 200 determines whether the interval is at a maximum wake interval (e.g., 16 ms). If the maximum interval has not been reached (block 912) the process continues to block 914. If the maximum interval has been reached (block 912) the process continues to block 916.

At block 914, the detector circuitry 200 increases the wake interval (e.g., from 2 ms to 3 ms). The detector circuitry 200 continues to run the algorithm (block 908) until the algorithm has tested the device at each incremental wake interval for the sleep state limit.

At block 916, the detector circuitry 200 determines whether a minimum sleep state limit has been tested for the device 104. If the minimum sleep state has not been tested (block 916), the process continues to block 918. Otherwise, the process ends.

At block 918, the detector circuitry 200 decreased the sleep state limit (e.g., from C10 to C8, from C8 to C6, etc.) such that the detector circuitry 200 can test the device and collect the power data for a new (e.g., different, next, etc.) sleep state limit. In some examples, the power data for new sleep state limit can be illustrated by plot 304, plot 404, and/or plot 504. In other examples, the power data for the new sleep state limit can be illustrated by plot 306, plot 406, and/or plot 506.

FIG. 10 is a flowchart representative of example machine readable instructions and/or example operations that may be executed and/or instantiated by processor circuitry to implement the computing device 104, as described above in conjunction with block 804 of FIG. 8. The machine readable instructions and/or operations of FIG. 10 begin at block 1000, at which the example identifier circuitry 204 starts a timer.

At block 1002, the identifier circuitry 204 detects the power data of a first sleep state. In some examples, the first sleep state is C10, power state 10, and/or sleep state 10. In some examples the power data of the first sleep state can be represented by plot 302, plot 402, and/or plot 502.

At block 1004, the identifier circuitry 204 detects the power data of a second sleep state. In some examples, the second sleep state is C8, power state 8, and/or sleep state 8. In some examples, the power data of the second sleep state can be represented by plot 304, plot 404, and/or plot 504.

At block 1006, the identifier circuitry 204 determines whether the power data of the first sleep state is equal to the power output at the second sleep state. For example, in the example of FIG. 4, when the plot 402 crosses the plot 404, then the power output data of the sleep state represented by plot 402 is equal to the power output data of the sleep state represented by plot 404. Additionally or alternatively, in the examples of FIG. 4, when the plot 406 crosses the plot 404, then the power output data of the sleep state represented by plot 406 is equal to the power output data of the sleep state represented by plot 404. If the power output data at the first sleep state does not equal the power output data of the second sleep state (block 1006) the process returns to block 1000. If the power output data at the first sleep state equals the power output data of the second sleep state (block 1006), the process continues to block 1008.

At block 1008, the identifier circuitry 204 stops the timer.

At block 1010, the identifier circuitry 204 records the wake interval at which the timer was stopped.

At block 1012, the identifier circuitry 204 identifies a crossover threshold. For example, in the example of FIG. 4, when the plot 406 crosses the plot 404, the identifier circuitry 204 identifies the crossover threshold 408. Additionally or alternatively, in the example of FIG. 4, when the plot 402 crosses the plot 404, the identifier circuitry 204 identifies the crossover threshold 410.

FIG. 11 is a block diagram of an example processor platform 1100 structured to execute and/or instantiate the machine readable instructions and/or the operations of FIGS. 7-10 to implement the computing device 104 of FIGS. 1 and 2. The processor platform 1100 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing device.

The processor platform 1100 of the illustrated example includes processor circuitry 1112. The processor circuitry 1112 of the illustrated example is hardware. For example, the processor circuitry 1112 can be implemented by one or more integrated circuits, logic circuits, FPGAs, microprocessors, CPUs, GPUs, DSPs, and/or microcontrollers from any desired family or manufacturer. The processor circuitry 1112 may be implemented by one or more semiconductor based (e.g., silicon based) devices. In this example, the processor circuitry 1112 implements detector circuitry 200, the example power analyzer circuitry 202, the example identifier circuitry 204, the example controller circuitry 206, the example assigner circuitry 208, the example power state controller circuitry 124, and the example power monitor 114.

The processor circuitry 1112 of the illustrated example includes a local memory 1113 (e.g., a cache, registers, etc.). The processor circuitry 1112 of the illustrated example is in communication with a main memory including a volatile memory 1114 and a non-volatile memory 1116 by a bus 1118. The volatile memory 1114 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1116 may be implemented by flash memory and/or any other desired type of memory device. Access to the main memory 1114, 1116 of the illustrated example is controlled by a memory controller 1117.

The processor platform 1100 of the illustrated example also includes interface circuitry 1120. The interface circuitry 1120 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1022 are connected to the interface circuitry 1120. The input device(s) 1122 permit(s) a user to enter data and/or commands into the processor circuitry 1112.

One or more output devices 1124 are also connected to the interface circuitry 1120 of the illustrated example. The output device(s) 1124 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1120 of the illustrated example, thus, typically includes a graphics driver card, a graphics driver chip, and/or graphics processor circuitry such as a GPU.

The interface circuitry 1120 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1126. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 1100 of the illustrated example also includes one or more mass storage devices 1128 to store software and/or data. Examples of such mass storage devices 1128 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives.

The machine executable instructions 1132, which may be implemented by the machine readable instructions of FIGS. 7-10, may be stored in the mass storage device 1128, in the volatile memory 1114, in the non-volatile memory 1116, and/or on a removable non-transitory computer readable storage medium such as a CD or DVD.

FIG. 12 is a block diagram of an example implementation of the processor circuitry 1112 of FIG. 11. In this example, the processor circuitry 1112 of FIG. 11 is implemented by a general purpose microprocessor 1200. The general purpose microprocessor circuitry 1200 executes some or all of the machine readable instructions of the flowcharts of FIGS. 7-10 to effectively instantiate the computing device 104 of FIGS. 1 and 2 as logic circuits to perform the operations corresponding to those machine readable instructions. In some such examples, the circuitry of FIGS. 1 and 2 are instantiated by the hardware circuits of the microprocessor 1200 in combination with the instructions. For example, the microprocessor 1200 may implement multi-core hardware circuitry such as a CPU, a DSP, a GPU, an XPU, etc. Although it may include any number of example cores 1202 (e.g., 1 core), the microprocessor 1200 of this example is a multi-core semiconductor device including N cores. The cores 1202 of the microprocessor 1200 may operate independently or may cooperate to execute machine readable instructions. For example, machine code corresponding to a firmware program, an embedded software program, or a software program may be executed by one of the cores 1202 or may be executed by multiple ones of the cores 1202 at the same or different times. In some examples, the machine code corresponding to the firmware program, the embedded software program, or the software program is split into threads and executed in parallel by two or more of the cores 1202. The software program may correspond to a portion or all of the machine readable instructions and/or operations represented by the flowcharts of FIGS. 7-10.

The cores 1202 may communicate by a first example bus 1204. In some examples, the first bus 1204 may implement a communication bus to effectuate communication associated with one(s) of the cores 1202. For example, the first bus 1204 may implement at least one of an Inter-Integrated Circuit (I2C) bus, a Serial Peripheral Interface (SPI) bus, a PCI bus, or a PCIe bus. Additionally or alternatively, the first bus 1204 may implement any other type of computing or electrical bus. The cores 1202 may obtain data, instructions, and/or signals from one or more external devices by example interface circuitry 1206. The cores 1202 may output data, instructions, and/or signals to the one or more external devices by the interface circuitry 1206. Although the cores 1202 of this example include example local memory 1220 (e.g., Level 1 (L1) cache that may be split into an L1 data cache and an L1 instruction cache), the microprocessor 1200 also includes example shared memory 1210 that may be shared by the cores (e.g., Level 2 (L2_cache)) for high-speed access to data and/or instructions. Data and/or instructions may be transferred (e.g., shared) by writing to and/or reading from the shared memory 1210. The local memory 1220 of each of the cores 1202 and the shared memory 1210 may be part of a hierarchy of storage devices including multiple levels of cache memory and the main memory (e.g., the main memory 1114, 1116 of FIG. 11). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1202 may be referred to as a CPU, DSP, GPU, etc., or any other type of hardware circuitry. Each core 1202 includes control unit circuitry 1214, arithmetic and logic (AL) circuitry (sometimes referred to as an ALU) 1216, a plurality of registers 1218, the L1 cache 1220, and a second example bus 1222. Other structures may be present. For example, each core 1202 may include vector unit circuitry, single instruction multiple data (SIMD) unit circuitry, load/store unit (LSU) circuitry, branch/jump unit circuitry, floating-point unit (FPU) circuitry, etc. The control unit circuitry 1214 includes semiconductor-based circuits structured to control (e.g., coordinate) data movement within the corresponding core 1202. The AL circuitry 1216 includes semiconductor-based circuits structured to perform one or more mathematic and/or logic operations on the data within the corresponding core 1202. The AL circuitry 1216 of some examples performs integer based operations. In other examples, the AL circuitry 1216 also performs floating point operations. In yet other examples, the AL circuitry 1216 may include first AL circuitry that performs integer based operations and second AL circuitry that performs floating point operations. In some examples, the AL circuitry 1216 may be referred to as an Arithmetic Logic Unit (ALU). The registers 1218 are semiconductor-based structures to store data and/or instructions such as results of one or more of the operations performed by the AL circuitry 1216 of the corresponding core 1202. For example, the registers 1218 may include vector register(s), SIMD register(s), general purpose register(s), flag register(s), segment register(s), machine specific register(s), instruction pointer register(s), control register(s), debug register(s), memory management register(s), machine check register(s), etc. The registers 1218 may be arranged in a bank as shown in FIG. 12. Alternatively, the registers 1218 may be organized in any other arrangement, format, or structure including distributed throughout the core 1202 to shorten access time. The second bus 1222 may implement at least one of an I2C bus, a SPI bus, a PCI bus, or a PCIe bus

Each core 1202 and/or, more generally, the microprocessor 1200 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1200 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

FIG. 13 is a block diagram of another example implementation of the processor circuitry 1112 of FIG. 11. In this example, the processor circuitry 1112 is implemented by FPGA circuitry 1300. The FPGA circuitry 1300 can be used, for example, to perform operations that could otherwise be performed by the example microprocessor 1200 of FIG. 12 executing corresponding machine readable instructions. However, once configured, the FPGA circuitry 1300 instantiates the machine readable instructions in hardware and, thus, can often execute the operations faster than they could be performed by a general purpose microprocessor executing the corresponding software.

More specifically, in contrast to the microprocessor 1200 of FIG. 12 described above (which is a general purpose device that may be programmed to execute some or all of the machine readable instructions represented by the flowcharts of FIGS. 7-10 but whose interconnections and logic circuitry are fixed once fabricated), the FPGA circuitry 1300 of the example of FIG. 13 includes interconnections and logic circuitry that may be configured and/or interconnected in different ways after fabrication to instantiate, for example, some or all of the machine readable instructions represented by the flowcharts of FIG. 7-10. In particular, the FPGA 1300 may be thought of as an array of logic gates, interconnections, and switches. The switches can be programmed to change how the logic gates are interconnected by the interconnections, effectively forming one or more dedicated logic circuits (unless and until the FPGA circuitry 1300 is reprogrammed). The configured logic circuits enable the logic gates to cooperate in different ways to perform different operations on data received by input circuitry. Those operations may correspond to some or all of the software represented by the flowcharts of FIG. 7-10. As such, the FPGA circuitry 1300 may be structured to effectively instantiate some or all of the machine readable instructions of the flowcharts of FIG. 7-10 as dedicated logic circuits to perform the operations corresponding to those software instructions in a dedicated manner analogous to an ASIC. Therefore, the FPGA circuitry 1300 may perform the operations corresponding to the some or all of the machine readable instructions of FIG. 13 faster than the general purpose microprocessor can execute the same.

In the example of FIG. 13, the FPGA circuitry 1300 is structured to be programmed (and/or reprogrammed one or more times) by an end user by a hardware description language (HDL) such as Verilog. The FPGA circuitry 1300 of FIG. 13, includes example input/output (I/O) circuitry 1302 to obtain and/or output data to/from example configuration circuitry 1304 and/or external hardware (e.g., external hardware circuitry) 1306. For example, the configuration circuitry 1304 may implement interface circuitry that may obtain machine readable instructions to configure the FPGA circuitry 1300, or portion(s) thereof. In some such examples, the configuration circuitry 1304 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 1306 may implement the microprocessor 1200 of FIG. 12. The FPGA circuitry 1300 also includes an array of example logic gate circuitry 1308, a plurality of example configurable interconnections 1310, and example storage circuitry 1312. The logic gate circuitry 1308 and interconnections 1310 are configurable to instantiate one or more operations that may correspond to at least some of the machine readable instructions of FIG. 13 and/or other desired operations. The logic gate circuitry 1308 shown in FIG. 13 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1308 to enable configuration of the electrical structures and/or the logic gates to form circuits to perform desired operations. The logic gate circuitry 1308 may include other electrical structures such as look-up tables (LUTs), registers (e.g., flip-flops or latches), multiplexers, etc.

The interconnections 1310 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1308 to program desired logic circuits.

The storage circuitry 1312 of the illustrated example is structured to store result(s) of the one or more of the operations performed by corresponding logic gates. The storage circuitry 1312 may be implemented by registers or the like. In the illustrated example, the storage circuitry 1312 is distributed amongst the logic gate circuitry 1308 to facilitate access and increase execution speed.

The example FPGA circuitry 1300 of FIG. 13 also includes example Dedicated Operations Circuitry 1314. In this example, the Dedicated Operations Circuitry 1314 includes special purpose circuitry 1316 that may be invoked to implement commonly used functions to avoid the need to program those functions in the field. Examples of such special purpose circuitry 1316 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1300 may also include example general purpose programmable circuitry 1318 such as an example CPU 1320 and/or an example DSP 1322. Other general purpose programmable circuitry 1318 may additionally or alternatively be present such as a GPU, an XPU, etc., that can be programmed to perform other operations.

Although FIGS. 12 and 13 illustrate two example implementations of the processor circuitry 1112 of FIG. 11, many other approaches are contemplated. For example, as mentioned above, modern FPGA circuitry may include an on-board CPU, such as one or more of the example CPU 1320 of FIG. 13. Therefore, the processor circuitry 1112 of FIG. 11 may additionally be implemented by combining the example microprocessor 1200 of FIG. 12 and the example FPGA circuitry 1300 of FIG. 13. In some such hybrid examples, a first portion of the machine readable instructions represented by the flowcharts of FIGS. 7-10 may be executed by one or more of the cores 1202 of FIG. 12, a second portion of the machine readable instructions represented by the flowcharts of FIGS. 7-10 may be executed by the FPGA circuitry 1300 of FIG. 13, and/or a third portion of the machine readable instructions represented by the flowcharts of FIGS. 7-10 may be executed by an ASIC. It should be understood that some or all of the circuitry of FIGS. 1 and 2 may, thus, be instantiated at the same or different times. Some or all of the circuitry may be instantiated, for example, in one or more threads executing concurrently and/or in series. Moreover, in some examples, some or all of the circuitry of FIGS. 1 and 2 may be implemented within one or more virtual machines and/or containers executing on the microprocessor.

In some examples, the processor circuitry 1112 of FIG. 11 may be in one or more packages. For example, the processor circuitry 1200 of FIG. 12 and/or the FPGA circuitry 1300 of FIG. 13 may be in one or more packages. In some examples, an XPU may be implemented by the processor circuitry 1112 of FIG. 11, which may be in one or more packages. For example, the XPU may include a CPU in one package, a DSP in another package, a GPU in yet another package, and an FPGA in still yet another package.

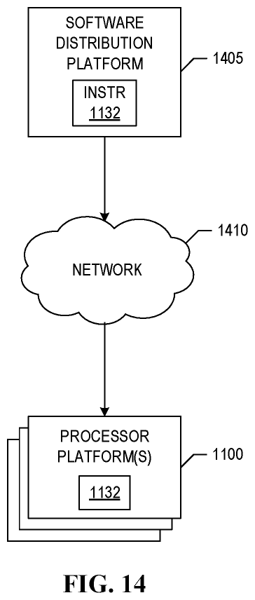

A block diagram illustrating an example software distribution platform 1405 to distribute software such as the example machine readable instructions 1132 of FIG. 11 to hardware devices owned and/or operated by third parties is illustrated in FIG. 14. The example software distribution platform 1405 may be implemented by any computer server, data facility, cloud service, etc., capable of storing and transmitting software to other computing devices. The third parties may be customers of the entity owning and/or operating the software distribution platform 1405. For example, the entity that owns and/or operates the software distribution platform 1405 may be a developer, a seller, and/or a licensor of software such as the example machine readable instructions 1132 of FIG. 11. The third parties may be consumers, users, retailers, OEMs, etc., who purchase and/or license the software for use and/or re-sale and/or sub-licensing. In the illustrated example, the software distribution platform 1405 includes one or more servers and one or more storage devices. The storage devices store the machine readable instructions 1132, which may correspond to the example machine readable instructions of FIGS. 7-10, as described above. The one or more servers of the example software distribution platform 1405 are in communication with a network 1410, which may correspond to any one or more of the Internet and/or any of the example network 1126 described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 1132 from the software distribution platform 1405. For example, the software, which may correspond to the example machine readable instructions of FIGS. 7-10, may be downloaded to the example processor platform 1100, which is to execute the machine readable instructions 1132 to implement the computing device 104. In some examples, one or more servers of the software distribution platform 1405 periodically offer, transmit, and/or force updates to the software (e.g., the example machine readable instructions 1132 of FIG. 10) to ensure improvements, patches, updates, etc., are distributed and applied to the software at the end user devices.

From the foregoing, it will be appreciated that example systems, methods, apparatus, and articles of manufacture have been disclosed that improve the power consumption of a computing device. Disclosed systems, methods, apparatus, and articles of manufacture improve the efficiency of using a computing device by identifying the sleep state of a computing device that requires the lowest power consumption, identifying wake intervals corresponding to optimal sleep states and crossover thresholds of the sleep states, and prolonging the battery life of the computing device by limiting (e.g., demoting) the device to the optimal sleep state. Disclosed systems, methods, apparatus, and articles of manufacture are accordingly directed to one or more improvement(s) in the operation of a machine such as a computer or other electronic and/or mechanical device.

Example 1 includes an apparatus to operate a battery of a computing device, the apparatus comprising interface circuitry, and processor circuitry including one or more of at least one of a central processing unit, a graphic processing unit or a digital signal processor, the at least one of the central processing unit, the graphic processing unit or the digital signal processor having control circuitry to control data movement within the processor circuitry, arithmetic and logic circuitry to perform one or more first operations corresponding to instructions, and one or more registers to store a result of the one or more first operations, the instructions in the apparatus, a Field Programmable Gate Array (FPGA), the FPGA including logic gate circuitry, a plurality of configurable interconnections, and storage circuitry, the logic gate circuitry and interconnections to perform one or more second operations, the storage circuitry to store a result of the one or more second operations, or Application Specific Integrate Circuitry (ASIC) including logic gate circuitry to perform one or more third operations, the processor circuitry to perform at least one of the first operations, the second operations or the third operations to instantiate detector circuitry to detect power output data of the computing device via a hardware power monitor, power analyzer circuitry to determine the power output data for sleep states of the computing device based on multiple wake intervals, identifier circuitry to identify crossover thresholds at ones of the multiple wake intervals, and controller circuitry to limit the computing device to the crossover thresholds at ones of the multiple wake intervals.

Example 2 includes the apparatus of example 1, further including assigner circuitry to determine the sleep states of the computing device based on at least one of the crossover thresholds.

Example 3 includes the apparatus of example 2, further including power state controller circuitry to receive the sleep states from the assigner circuitry, the power state controller circuitry to control the sleep states of the computing device.

Example 4 includes the apparatus of example 1, wherein the detector circuitry is to detect the power output data at an input of a voltage regulator (VR).

Example 5 includes the apparatus of example 1, wherein the detector circuitry is to detect the power output data via at least one of a platform power monitor of the computing device or a system on a chip (SoC) power monitor of the computing device.

Example 6 includes the apparatus of example 1, wherein the identifier circuitry is to identify at least one of the crossover thresholds when first power output data of a first sleep state is equal to second power output data of a second sleep state, the first sleep state different from the second sleep state.

Example 7 includes the apparatus of example 6, wherein the first sleep state is C-6 and the second sleep state is C-8.

Example 8 includes the apparatus of example 6, wherein the at least one of the crossover thresholds occurs at a wake interval of 4.5 milliseconds (ms).

Example 9 includes the apparatus of example 1, wherein the computing device is a customer computing device.

Example 10 includes the apparatus of example 1, further including the controller circuitry to limit the computing device to a higher sleep state based on at least one of the crossover thresholds.

Example 11 includes a non-transitory computer readable storage medium comprising instructions which, when executed, cause at least one processor to at least detect power output data of a computing device via a hardware power monitor, determine the power output data for sleep states of the computing device based on multiple wake intervals, identify crossover thresholds at ones of the multiple wake intervals, and limit the computing device to the crossover thresholds at ones of the multiple wake intervals.

Example 12 includes the computer readable storage medium of example 11, wherein the instructions cause the at least one processor to determine sleep states of the computing device based on at least one of the crossover thresholds.

Example 13 includes the computer readable storage medium of example 12, further including the instructions to cause the at least one processor to control the sleep states of the computing device.

Example 14 includes the computer readable storage medium of example 11, wherein the instructions cause the at least one processor to detect the power output data at an input of a voltage regulator (VR).

Example 15 includes the computer readable storage medium of example 11, wherein the instructions cause the at least one processor to detect the power output data via at least one of a platform power monitor of the computing device or a system on a chip (SoC) power monitor of the computing device.

Example 16 includes the computer readable storage medium of example 11, wherein the instructions cause the at least one processor to identify at least one of the crossover thresholds when first power output data of a first sleep state is equal to second power output data of a second sleep state, the first sleep state different from the second sleep state.

Example 17 includes the computer readable storage medium of example 11, wherein the instructions cause the at least one processor to limit the computing device to a higher sleep state based on at least one of the crossover thresholds.

Example 18 includes a method to operate a battery of a computing device, the method comprising detecting power output data of a computing device via a hardware power monitor, determining the power output data for sleep states of the computing device based on multiple wake intervals, identifying crossover thresholds at ones of the multiple wake intervals, and limiting the computing device to the crossover thresholds at ones of the multiple wake intervals.

Example 19 includes the method of example 18, further including determining sleep states of the computing device based on at least one of the crossover thresholds.

Example 20 includes the method of example 19, further including controlling the sleep states of the computing device.

Example 21 includes the method of example 18, wherein detecting the power output data via a hardware power monitor further includes detecting the power output data at an input of a voltage regulator (VR).

Example 22 includes the method of example 18, wherein detecting the power output data via a hardware power monitor further includes detecting the power output data via at least one of a platform power monitor of the computing device or a system on a chip (SoC) power monitor of the computing device.

Example 23 includes the method of example 18, further including identifying at least one of the crossover thresholds when first power output data of a first sleep state is equal to second power output data of a second sleep state, the first sleep state different from the second sleep state.

Example 24 includes the method of example 18, further including limiting the computing device to a higher sleep state based on at least one of the crossover thresholds.

Example 25 includes an apparatus to operate a battery of a computing device, the apparatus comprising means for detecting power output data of a computing device via a hardware power monitor, means for determining the power output data for sleep states of the computing device based on multiple wake intervals, means for identifying crossover thresholds at ones of the multiple wake intervals, and means for limiting the computing device to the crossover thresholds at ones of the multiple wake intervals.

Example 26 includes the apparatus of example 25, further including means for assigning to determine the sleep states of the computing device based on at least one of the crossover thresholds.

Example 27 includes the apparatus of example 26, further including means for controlling to control the sleep states of the computing device.

Example 28 includes the apparatus of example 25, wherein the means for detecting is to detect the power output data at an input of a voltage regulator (VR).

Example 29 includes the apparatus of example 25, wherein the means for detecting is to detect the power output data via at least one of a platform power monitor of the computing device or a system on a chip (SoC) power monitor of the computing device.

Example 30 includes the apparatus of example 25, wherein the means for identifying is to identify at least one of the crossover thresholds when first power output data of a first sleep state is equal to second power output data of a second sleep state, the first sleep state different from the second sleep state.

Example 31 includes the apparatus of example 25, wherein the means for limiting is to limit the computing device to a higher sleep state based on at least one of the crossover thresholds.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

The following claims are hereby incorporated into this Detailed Description by this reference, with each claim standing on its own as a separate embodiment of the present disclosure.

1. An apparatus to operate a battery of a computing device, the apparatus comprising:
interface circuitry;
machine readable instructions; and
programmable circuitry to at least on of instantiate or execute the machine readable instructions to:
detect power output data of the computing device via a hardware power monitor;
determine the power output data for sleep states of the computing device based on multiple wake intervals;
to identify crossover thresholds at ones of the multiple wake intervals; and
limit the computing device to the crossover thresholds at ones of the multiple wake intervals.

2. The apparatus of claim 1, wherein the programmable circuitry is to determine the sleep states of the computing device based on at least one of the crossover thresholds.

3. The apparatus of claim 2, wherein the programmable circuitry is to:
receive the sleep states from the assigner circuitry; and
control the sleep states of the computing device.

4. The apparatus of claim 1, wherein the programmable circuitry is to detect the power output data at an input of a voltage regulator (VR).

5. The apparatus of claim 1, wherein the programmable circuitry is to detect the power output data via at least one of a platform power monitor of the computing device or a system on a chip (SoC) power monitor of the computing device.

6. The apparatus of claim 1, wherein the identifier programmable circuitry is to identify at least one of the crossover thresholds when first power output data of a first sleep state is equal to second power output data of a second sleep state, the first sleep state different from the second sleep state.

7. The apparatus of claim 6, wherein the first sleep state is C-6 and the second sleep state is C-8.

8. The apparatus of claim 6, wherein the at least one of the crossover thresholds occurs at a wake interval of 4.5 milliseconds (ms).

9. The apparatus of claim 1, wherein the computing device is a customer computing device.

10. The apparatus of claim 1, wherein the programmable circuitry is to limit the computing device to a higher sleep state based on at least one of the crossover thresholds.

11. A non-transitory computer readable storage medium comprising instructions which, when executed, cause at least one processor to at least:
detect power output data of a computing device via a hardware power monitor;
determine the power output data for sleep states of the computing device based on multiple wake intervals;
identify crossover thresholds at ones of the multiple wake intervals; and
limit the computing device to the crossover thresholds at ones of the multiple wake intervals.

12. The computer readable storage medium of claim 11, wherein the instructions cause the at least one processor to determine sleep states of the computing device based on at least one of the crossover thresholds.

13. The computer readable storage medium of claim 12, further including the instructions to cause the at least one processor to control the sleep states of the computing device.

14. The computer readable storage medium of claim 11, wherein the instructions cause the at least one processor to detect the power output data at an input of a voltage regulator (VR).

15. The computer readable storage medium of claim 11, wherein the instructions cause the at least one processor to detect the power output data via at least one of a platform power monitor of the computing device or a system on a chip (SoC) power monitor of the computing device.

16. The computer readable storage medium of claim 11, wherein the instructions cause the at least one processor to identify at least one of the crossover thresholds when first power output data of a first sleep state is equal to second power output data of a second sleep state, the first sleep state different from the second sleep state.

17. The computer readable storage medium of claim 11, wherein the instructions cause the at least one processor to limit the computing device to a higher sleep state based on at least one of the crossover thresholds.

18. A method to operate a battery of a computing device, the method comprising:
detecting power output data of a computing device via a hardware power monitor;
determining the power output data for sleep states of the computing device based on multiple wake intervals;
identifying crossover thresholds at ones of the multiple wake intervals; and
limiting the computing device to the crossover thresholds at ones of the multiple wake intervals.

19.-23. (canceled)

24. The method of claim 18, further including limiting the computing device to a higher sleep state based on at least one of the crossover thresholds.

25.-31. (canceled)
